(19) United States
(12) Patent Application Publication
(10) Pub. No.: US 2008/0189199 A1
(43) Pub. Date: Aug. 7, 2008

(54) ON-LINE TRADING OF PROSPECTIVE CUSTOMER LEADS

(75) Inventors: Sahar SARID, Pompano Beach, FL (US); Kishore Bhavnanie, Bethlehem, PA (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Ashantiplc, Ltd., Hong Kong (HK)

(21) Appl. No.: 11/670,716

(22) Filed: Feb. 2, 2007

(51) Int. Cl. G06Q 40/00

(52) U.S. Cl. 705/37

(57) ABSTRACT

A system and method for providing an on-line trading environment of partial-disclosure informational leads are disclosed. The method includes presenting an on-line auction to a user. The on-line auction is for auctioning partial-disclosure informational leads to users. The method also includes receiving a bid request from the user for the partial-disclosure informational lead being auctioned in the on-line auction. Real-time information representing auction events can be transmitted by the system to the user, contemporaneous with the auction events occurring. The transmission of the real-time information is unevoked by the user.

### FIELD OF THE INVENTION

The present invention generally relates to the field of on-line trading environments, and more particularly relates to on-line trading of information.

### BACKGROUND OF THE INVENTION

The Internet has become an open market for all types of goods and services. On-line auctioning sites have become very popular over the recent years. Generally, an on-line auction comprises a selling party, one or more bidding parties, and one or more items for sale. During the auction, bidding parties place bids on the one or more items for sale in which the highest bidder at the end of the auction wins the item(s). Alternatively, the auction can start with a high sale price that is decreased until a bidder accepts the current price. Additionally, an auction can end if a fixed sale price is matched by one of the bidders.

One problem with current on-line auction sites is that they mostly provide a forum for sellers to offer tangible goods such as clothing, jewelry, electronics, collectibles, hardware, automobiles, and the like. Current on-line auction sites do not provide a market place for the trading of information leads by which sellers or service providers may contact qualified buyers or prospective customers. Additionally, current on-line auction sites typically provide full disclosure of all relevant information describing the one or more items being auctioned. This is normally needed so that all bidders have full disclosure and can make an educated decision as to what amount to bid for the item(s) being auctioned. Lastly, current on-line auction approaches typically require a bidder to request the latest bid and other related bidding information from the site to have access to the needed information to be able to place a bid on an ongoing live auction. Unfortunately, due to high paced bidding that can take place at an on-line auction, by the time a bidder has obtained the requested bidding information from the site the on-line auction for the particular item(s) can be over, leaving the bidder with a lost opportunity to bid on the item(s).

Therefore, a need exists to overcome the problems with the prior art as discussed above.

### SUMMARY OF THE INVENTION

Briefly, in accordance with embodiments of the present invention, disclosed are a system and method for providing an on-line trading environment of partial-disclosure informational leads. The method comprises presenting an on-line auction to a user. The on-line auction is for auctioning partial-disclosure informational leads to users. For example, partial disclosure information can be auctioned to sellers or brokers seeking informational leads relating to potential buyers. The method also includes receiving a bid request from the user for the partial-disclosure information in the auction.

In another embodiment, a method for providing an on-line trading environment of partial-disclosure informational leads associated with prospective customers is disclosed. The method includes presenting an on-line auction to a user. The on-line auction presents to the user partial-disclosure informational leads indicating a commercial interest of a prospective customer. A bid request is received from the user on the basis of the partial-disclosure informational leads in the on-line auction. The bid request represents an offer for purchasing full disclosure information associated with the partial-disclosure informational leads for identifying the prospective customer.

In yet another embodiment, a system for providing an on-line trading environment of partial-disclosure informational leads is disclosed. The system comprises a memory and an information processing system communicatively coupled to the memory. The information processing system provides an on-line auction environment and a user interface for the on-line auction. The on-line auction user interface allows a user to interact with a partial-disclosure informational lead auction. The user interface receives at least a bid request from the user for the partial-disclosure informational lead in the auction.

An advantage of an embodiment of the present invention is that an effective on-line environment for trading partial-disclosure information is provided. Also, bidders can receive timely information from the on-line auction site to support their ongoing bidding decisions for placing bids during a live on-line auction.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a network system suitable for use with an on-line trading environment according to an embodiment of the present invention;

FIG. 2 is a block diagram illustrating an on-line trading server according to an embodiment of the present invention;

FIG. 3 is a schematic diagram of an on-line auction user interface according to an embodiment of the present invention;

FIG. 4 illustrates an example of partial-disclosure information used with an on-line auction according to an embodiment of the present invention;

FIG. 5 illustrates an example of full-disclosure information used with an on-line auction according to an embodiment of the present invention;

FIG. 6 is an operational flow diagram illustrating an example of an on-line auction system and user interface operating to determine a quality rating for informational leads according to an embodiment of the present invention;

FIG. 7 is an operational flow diagram illustrating an example of an on-line auction system and user interface operating to determine a quality rating for an owner of an informational lead according to an embodiment of the present invention;

FIG. 8 is an operational flow diagram illustrating an example of an overall process of auctioning partial disclosure information in an on-line environment according to an embodiment of the present invention; and

FIG. 9 is an operational flow diagram illustrating an example of an overall process of assigning a quality rating to partial disclosure information to be auctioned according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention, according to an embodiment, overcomes problems with the prior art by providing an on-line trading environment for informational leads where auctions present partial disclosure information associated with the leads. The present invention provides a forum where sellers wanting to sell an item/provide a service or brokers seeking informational leads relating to potential buyers can place bids on information associated with potential buyers. In other words, partial disclosure information associated with a potential buyer is presented to interested parties such as sellers or brokers in an auction.

The partial disclosure information provides enough information for a bidder (e.g., seller or broker) to make an informed decision on whether or not to place a bid without revealing any identifiable information associated with the potential buyer that permits a bidder to circumvent the auction system by contacting the potential buyer directly. The interested party places a bid on the partial disclosure information in order to “win” full disclosure information associated with the potential buyer.

Exemplary System

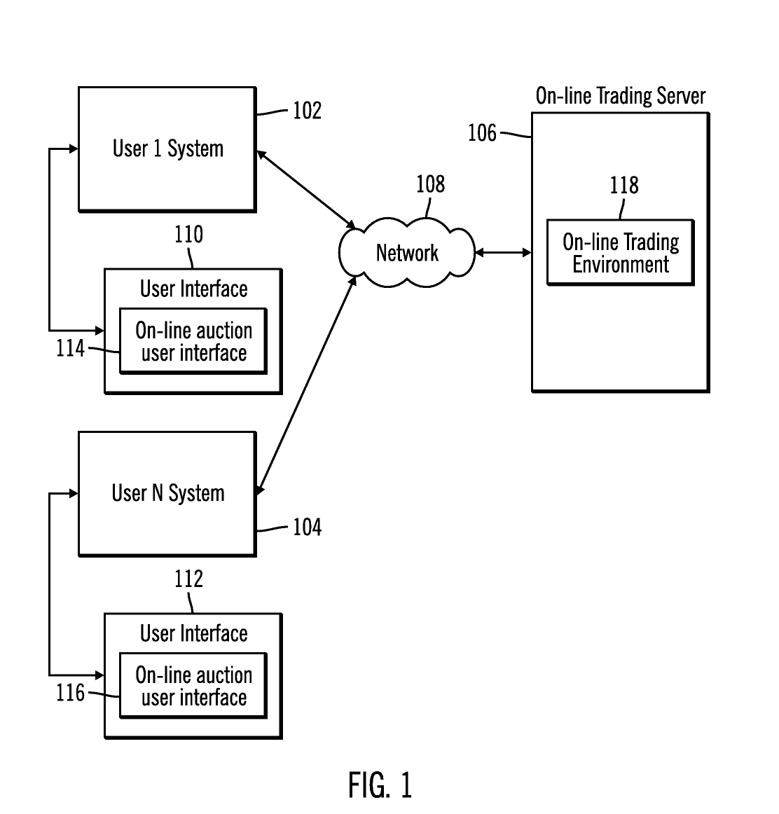

According to an embodiment of the present invention, as shown in FIG. 1, an exemplary system 100 is illustrated. FIG. 1 shows a system 100 comprising a plurality of user systems 102, 104. Each of the user systems 102, 104 communicate with an on-line trading server 106 through a network 108. The user systems 102, 104, in one embodiment, are personal computers, notebook computers, workstations, PDAs, cellular phones capable of browsing the Internet, and the like. The network 108, according to one embodiment, comprises a LAN, WAN, World Wide Web, wireless network, or the like. The user systems 102, 104, for example, are communicating with the on-line trading server 106 to search for and send bid requests related to particular on-line auctions.

In one embodiment, the on-line auctions present partial disclosure information. Stated differently, an on-line auction presents partial disclosure information to an interested party to entice that party to place a bid in order to receive full disclosure information associated with the potential buyer.

The partial disclosure information, for example, is a subset of information that is associated with an individual(s) or entity(s), that is interested in purchasing, renting, leasing (and the like) a particular item(s). The partial disclosure information generally indicates a commercial interest of a prospective customer without identifying the prospective customer. The identity and/or contact information of the individual(s) or entity(s) is not identifiable from the partial disclosure information. In other words, the partial disclosure information, in one embodiment, is associated with a party interested in a particular type of item or service for sale.

The winning bidder of an auction presenting partial disclosure information, in one embodiment, receives full disclosure information that identifies the prospective customer. The full disclosure information allows a winning bidder to contact the prospective buyer. Furthermore, a prospective customer is not limited to an individual interested in obtaining an item. For example, a prospective customer can be a broker or lead generator that is in possession of identifying information of consumers that are interested in goods/services indicated in the auction.

The user systems 102, 104 are communicatively coupled to a user interface 110, 112, such as a display so that a user can interact with an on-line auction user interface 114, 116 provided by the on-line trading server 106. The on-line auction user interface 114, 116 allows the user to interact with the on-line trading server 106 to search for and bid on auctions associated with particular partial disclosure information. The on-line auction user interface 114, 116 is discussed in greater detail below.

The on-line trading server 106 includes an on-line trading environment 118, which is discussed in greater detail below. In one embodiment, the on-line trading server 106 receives one or more partial disclosure information auction search requests and/or bid requests from a user through the on-line auction user interface 114, 116. The on-line trading server 106 is discussed in greater detail below.

On-Line Trading Server

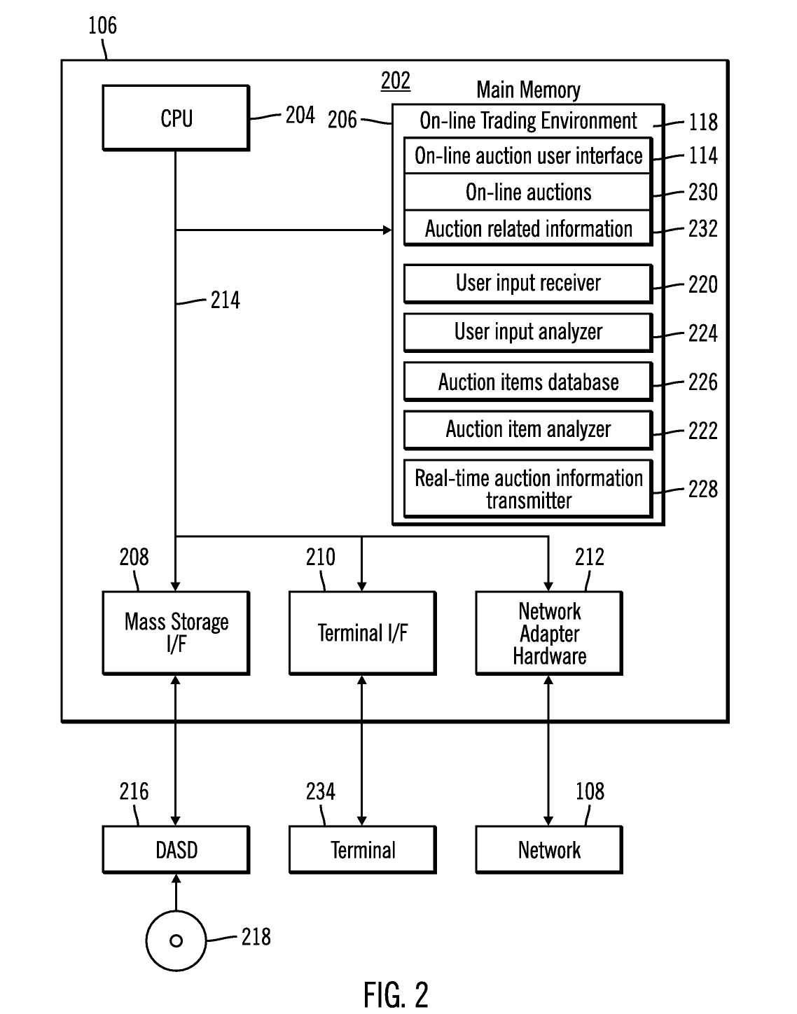

FIG. 2 is a block diagram illustrating a more detailed view of the on-line trading server 106 according to an embodiment of the present invention. The on-line trading server 106 is based upon a suitably configured information processing system adapted to implement the exemplary embodiment of the present invention. Any suitably configured information processing system is similarly able to be used as the on-line trading server 106 by embodiments of the present invention, for example, a personal computer, workstation, or the like.

The on-line trading server 106 includes a computer 202. The computer 202 has a processor 204 that is connected to a main memory 206, a mass storage interface 208, a terminal interface 210, and network adapter hardware 212. A system bus 214 interconnects these system components. Mass storage interface 208 is used to connect mass storage devices, such as a data storage device 216, to the on-line trading server 106. One specific type of data storage device is a CD drive, which may be used to store data to and read data from a CD-ROM 218. Another type of data storage device is a data storage device configured to support NTFS type file system operations.

In one embodiment, the program memory 206 comprises the on-line trading environment 118, a user input receiver 220, an auction item analyzer 222, user input analyzer 224, an auction item database 226, and an optional real-time auction information transmitter 228. In one embodiment, the on-line trading environment 118 includes the on-line auction user interface 114, on-line auctions 230, and auction related information 232. It should be noted that the on-line trading environment 118 is not limited to these components.

The on-line auction user interface 114 allows a user to interact with the on-line trading environment 118. The on-line auction user interface 114 is discussed in greater detail below. The on-line auctions 230, in one embodiment, are the auctions for partial disclosure information that are displayed to a user through the on-line auction user interface 114. In one embodiment, each on-line auction 230 is associated with auction related information 232. This information can be, but is not limited to, a description of the partial disclosure information, a picture(s) of an item that a potential buyer is interested in, time remaining for the auction, current high bidder, current bid price, bid history, and the like. A potential buyer, in one embodiment, is the party associated with the partial disclosure information. For example, partial disclosure information comprises information such as the type of item, price range the potential buyer is willing to spend on the item, and the like.

The party associated with the partial disclosure information is not limited to being interested in purchasing an item. For example, the party may also want to lease or rent an item instead. However, information that can identify the potential buyer is not included in the partial disclosure information. The partial disclosure information includes enough information for a bidder, which usually has a particular item to sell, to decide whether or not to place a bid on the auction.

The user input receiver 220, in one embodiment, receives an auction search request or a bid request. For example, a user can search for a particular auction or auctions related to keywords through the on-line auction user interface 114. If a user places a bid request for a particular auction(s), the user input analyzer 224 analyzes the bid request to determine if the bid request is higher than a given threshold. For example, the threshold can be a current high bid on the auction, a reserve price, a starting bid price, a fixed sale price, and the like. If the bid request does not meet or exceed the given threshold, the bid request, in one embodiment, is rejected and the user is notified. The user can then place another bid request. On the other hand, if the received bid request is higher than the given threshold then the server 106 sets a user id associated with the bidder as a current high bidder for the particular auction.

The auction item database 226, which is not limited to residing on the on-line trading server 106, can include each partial disclosure information that is being auctioned or that will be auctioned in the future. The auction item database 226, in one embodiment, also includes full disclosure information that is associated with partial disclosure information. Full disclosure information, in one embodiment, includes information that can identify a potential buyer such as contact information. In one embodiment, partial disclosure information is extracted from the full disclosure information to be auctioned. By only presenting the partial disclosure information during an auction, a user is not able to circumvent the auction and contact the potential lead without winning the auction. Examples of partial disclosure information and full disclosure information are discussed in greater detail below.

The auction item analyzer 222, in one embodiment, analyzes the full disclosure information including the partial disclosure information to determine a quality rating for the information. The quality rating, in one embodiment, represents the “readiness” of the party associated with the partial/full disclosure information to purchase, rent, or lease the item the party is interested in. The “readiness” can be determined, for example, by a time frame listed by the party for obtaining the item such as an immediate purchase, possible purchase, and the like. In another embodiment, the quality rating can also indicate the ability of a party to purchase, rent, or lease, an item. For example, a party can disclose salary information, method of payment, and the like. “Readiness” can also be graded as a function of the source, i.e., a general “price guide” site, or a mortgage lender who has pre-qualified a buyer are two variant degrees of “readiness”.

In another embodiment, the administrator of the on-line trading environment 118 manually assigns a quality rating to the information based on the above elements. Full disclosure information can be collected in various ways. For example, parties interested in purchasing, renting, or leasing an item can contact the on-line trading site. Based on the information given by the party, the administrator of the on-line auctioning site can then manually assign a quality rating to the information. Additionally, a third party can perform the quality rating procedure for the information. In other words, the quality rating procedure is not limited to an internal procedure of the online-trading site. In one embodiment, the online-auctioning site can also be a repository for third-party leads. The third-parties can assign a quality rating to their information leads or the rating can be assigned by the on-line auctioning site when the lead is submitted. In another embodiment, the owner of an informational lead can also be assigned a quality rating. For example, based on the owner's history (e.g., number of auctions, number of repeat customers, and the like) a quality rating is generated and assigned to the owner.

The optional real-time auction information transmitter 228, in one embodiment, pushes real-time auction information to subscribers of a particular auction. The transmission of real-time information is unevoked by the subscribers or users (the bidders). For example, a user can subscribe to an on-line auction and to the real-time push delivery service. The user can select in advance from one or more different ways that on-line auction real-time information should be delivered to the user during a live auction. As events or conditions associated with a given live auction occur, the real-time information transmitter 228 transmits information associated with the auction events or conditions as they occur in the live on-line auction.

A subscribing user can be informed of these events or conditions with negligible delay. Events or conditions can include, for example, a new bid has been received by the on-line auction site, a new current high bidder has been accepted by the auction site, a given time period existing before an auction ends (or expires) is determined by the auction site, a cancellation of an auction is determined by the auction site, and the like. Advantageously, bidders can receive timely information from the on-line auction site to support their ongoing bidding decisions for placing bids during a live on-line auction. By sending ongoing transmission of the real-time information associated with a live on-line auction from the auction site to all subscribing bidders, the transmissions are unevoked by the users (the bidders). A bidder subscribing to this unevoked transmissions on-line auction arrangement does not have to repeatedly request the latest bid and other related bidding information from the on-line auction site to have access to the needed real-time information to be able to place a bid on an ongoing live auction.

Although illustrated as concurrently resident in the main memory 206, it is clear that respective components of the main memory 206 are not required to be completely resident in the main memory 206 at all times or even at the same time. In one embodiment, the on-line trading server 106 utilizes conventional virtual addressing mechanisms to allow programs to behave as if they have access to a large, single storage entity, referred to herein as a computer system memory, instead of access to multiple, smaller storage entities such as the main memory 206 and data storage device 216. Note that the term “computer system memory” is used herein to generically refer to the entire virtual memory of the on-line trading server 106.

Although only one CPU 204 is illustrated for the computer 202, computer systems with multiple CPUs can be used equally effectively. Embodiments of the present invention further incorporate interfaces that each includes separate, fully programmed microprocessors that are used to off-load processing from the CPU 204. Terminal interface 210, according to one embodiment, is used to directly connect one or more terminals 228 to computer 202 to provide a user interface to the on-line trading server 106. These terminals 234, which are able to be non-intelligent or fully programmable workstations, are used to allow system administrators and users to communicate with the on-line trading server 106. The terminal 234 is also able to consist of user interface and peripheral devices that are connected to computer 202 and controlled by terminal interface hardware included in the terminal I/F 210 that includes video adapters and interfaces for keyboards, pointing devices, mp3 players, PDA docking stations, and the like.

An operating system (not shown) is also included in the main memory 206 and is a suitable multitasking operating system such as the Windows XP or Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the on-line trading server 106 or in an alternative embodiment, the user systems 102, 104.

The network adapter hardware 212 is used to provide an interface to the network 108. Embodiments of the present invention are able to be adapted to work with any data communications connections including present day analog and/or digital techniques and/or via any networking mechanism such as wired, wireless, local area, and wide area networks, and any other types of networks and communications links as should be obvious to those of ordinary skill in the art in view of the present discussion.

Although the exemplary embodiments of the present invention are described in the context of a fully functional computer system, those skilled in the art will appreciate that embodiments are capable of being distributed as a program product via floppy disk, e.g. CD ROM 218, floppy disk (not shown), or other form of recordable media, or via any type of electronic transmission mechanism.

On-Line Auction User Interface

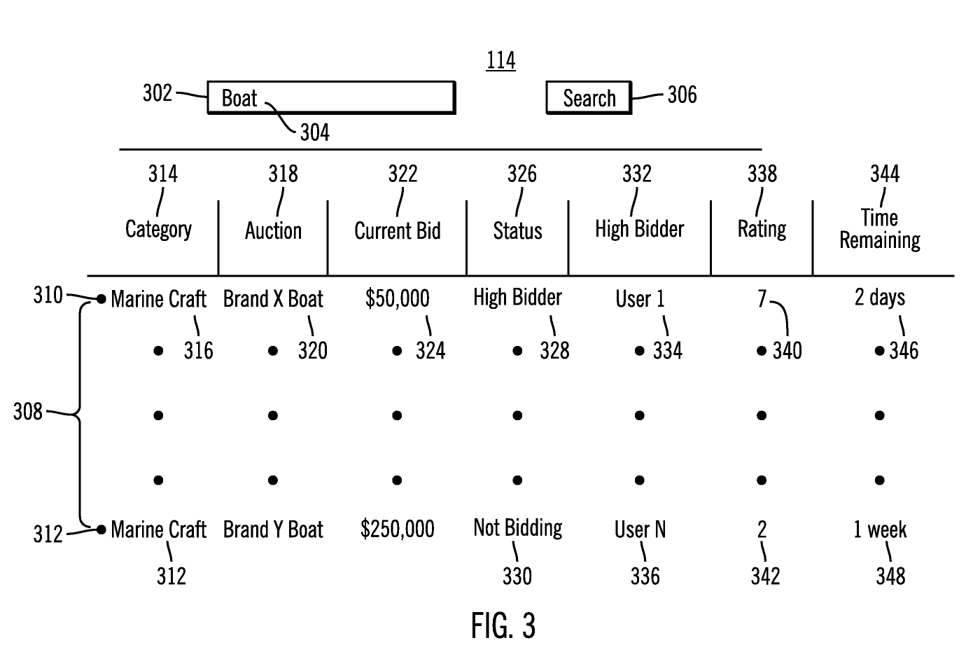

FIG. 3 shows a detailed view of the on-line auction user interface 114 according to an embodiment of the present invention. It is noted the on-line auction user interface 114 illustrated in FIG. 3 is only an exemplary embodiment and may include or not include one or more additional components. The on-line auction user interface 114 allows a user to search for and bid on auctions 230 presenting partial disclosure information for a full disclosure end product. The on-line auction user interface 114, in one embodiment, also allows a user to view a description of an auction 230 presenting partial disclosure information.

The on-line auction user interface 114 includes a search box 302. The search box 302 allows a user to enter one or more keywords 304 to search for auctions related to those keywords. For example, a boat dealer in Florida may have a 1997 Brand X boat for sale and desires to find a buyer fitting the criteria “buyer within X miles of Fort Lauderdale interested in buying a boat—powerboat—Brand X—within price range of Y”. These search criteria can be entered into the search box 302 for locating auctions presenting partial disclosure information matching the search criteria. The boat dealer can then decide whether or not to place a bid on the auction (presenting partial disclosure information) to obtain the full disclosure information associated with the potential buyer.

FIG. 3 shows an example where keyword 304 “boat” has been entered in to the search box 302. A search button 306 is also included that allows the user to initiate the auction search. After the search is completed a list of auctions 308 that are associated with the keyword(s) 304 is displayed to the user. For example, an auction 310 entitled “Brand X Boat” and an auction 312 entitled “Brand Y Boat” are displayed. The on-line auction user interface 114, in one embodiment, includes various columns comprising auction related information 232 associated with each displayed auction. For example, a category column 314 includes a category type for an auction.

FIG. 3 shows a category entry 316 for “marine craft” indicating that the auction 310 is for a marine craft item. An auction column 318 includes auction title entries 320 including the title of the auction. For example, the auction title entry 318 under the auction column 318 includes the title “Brand X Boat” for the first auction 310. In one embodiment, the title of an auction can indicate the type of item that a potential buyer is interested in obtaining. A current bid column 322 can also be included that lists the current bid price of a particular auction. For example, the current bid column 322 includes an entry 324 indicating that the current bid price on the first partial disclosure auction 310 is $50,000. A status column 326 can also be displayed that indicates the user's current status with respect to a partial disclosure information auction. For example, a status entry 328 for the first auction 310 indicates that the user is the high bidder for that auction. However, an entry 330 for the last auction 312 indicates that the user has not placed a bid on the last auction.

A high bidder column 332 can be included for displaying the user ID of the current high bidder for a particular partial disclosure information auction. For example, a high bidder entry 334 associated with the first auction 310 indicates that user 1 is the high bidder. A high bidder entry 336 associated with the last auction 312 indicates that user N is the high bidder. A rating column 338 can be also displayed for indicating a quality metric of the partial-disclosure information, i.e., the quality of the partial disclosure information. As discussed above, the quality rating can represent a party's “readiness” to obtain a good or service, such as to purchase a good or service. It can also represent the party's “willingness” and “ability” to obtain the good or service, and/or to make the purchase. Further, the quality metric can represent other aspects of the partial-disclosure information to indicate to a prospective bidder what the potential value is of the information that is up for bid. The quality metric associated with the partial-disclosure information provides the bidder(s) with a reliable indication of the value of the information up for bid without having the full-disclosure information associated therewith.

In one embodiment, a higher quality rating indicates that the party is looking to obtain the item sooner than a lower quality rating. For example, a quality rating entry 340 associated with the first auction 310 may show a quality rating of seven 340. A quality rating entry of two 342 is associated with the last auction 312. In one embodiment, a quality rating of seven 340 indicates, for example, that a buyer (the information lead) wants to obtain an item, and/or wants to make a purchase, in a shorter time period than a buyer associated with the last auction 312 having the quality rating of 2.

However, the present invention is not limited to this particular configuration for presenting quality metrics associated with on-line auctions. In another embodiment, for example, the list of on-line auctions 308 can include on-line auctions within a specific range of quality ratings. For example, a user (a bidder) can request that a list of on-line auctions associated with a quality rating between 7 and 10 be displayed. Other ways of arranging for a user the on-line auctions relative to their quality metrics should become obvious to those of ordinary skill in the art in view of the present discussion. For example, various types of Boolean logic and combinatorial arrangements can be provided to users of an on-line auction site to customize their selections of what on-line auctions, and associated with what quality metrics, they would want to see displayed for their consideration to participate in these displayed auctions.

Additionally, a time remaining column 344 can also be included for displaying the amount of time remaining before the auction ends. For example, a time remaining entry 346 associated with the first auction 310 indicates that two days are left before the auction ends (or closes). It should be noted that the present invention is not limited to the columns discussed above. Any one of the columns can be deleted from the on-line auction user interface 114 and one ore more additional columns can be added.

Partial Disclosure Information

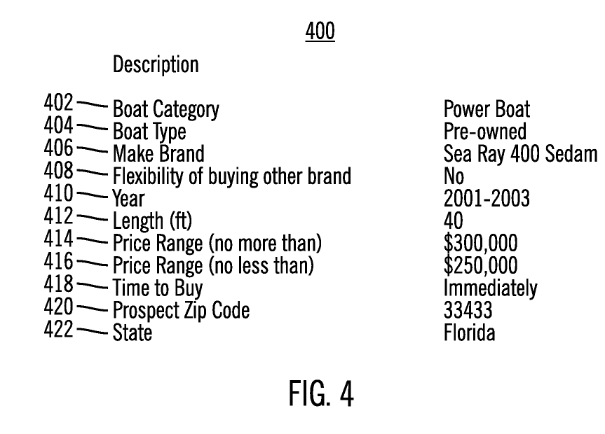

FIG. 4 shows exemplary partial-disclosure information 400. It should be noted that the various types of information shown in FIG. 4 are exemplary and not limiting. Partial-disclosure information gives an auction bidder enough information to make a decision whether or not to bid on the auction without receiving the full-disclosure information that completely identifies the party (the information lead) associated with the partial-disclosure information. For example, FIG. 4 shows information related to a boat category 402, boat type 404, and the boat make 406 that the potential buyer is interested in obtaining. For example, the potential buyer associated with the partial disclosure information 400 is interested in a power boat that is pre-owned and is a Brand X type boat.

FIG. 4 also shows a flexibility entry 408 indicating whether or not the party is flexible with the item make, model, or the like. Other information related to the item can also be displayed. For example, because the potential buyer associated with the partial disclosure information 400 shown in FIG. 4 is interested in a boat, the boat length 412 required by the potential buyer can be shown. The model year 410 of the item that the potential buyer is interested can also be shown. The partial disclosure information 400 can also include a minimum price range 414 and a maximum price range 416 that the potential buyer wants to spend on purchasing, renting, or leasing the item. A time period 418 indicates how interested the potential buyer is in obtaining the item. In one embodiment, a time range (not shown) can also be included to give a potential bidder a better idea of the potential buyer's “readiness” in obtaining an item. In one embodiment, the time period 418 and/or time range (not shown), among other things, are used to determine a quality rating (or quality metric) for the partial-disclosure information.

A zip code 420 and the state 422 associated with the potential buyer can also be included in the partial-disclosure information 400. As can be seen, the information included in the partial-disclosure information 400 does not fully reveal the identity of the potential buyer associated with the information 400. However, a potential bidder is given sufficient information to determine if the auction is worth bidding on to obtain the complete contact information of the potential buyer, renter, or lessee. Additional information (not shown) such as date of birth, employment type, marriage status, yearly income, and the like can also be included in the partial-disclosure information 400, according to particular implementations of different types of on-line auction sites.

Full Disclosure Information

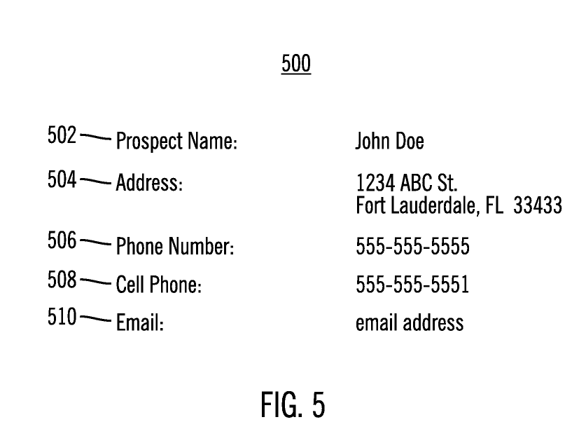

FIG. 5 shows exemplary full-disclosure information 500 that a winning bidder receives after an auction has ended. Full-disclosure information 500, for example, comprises information that fully identifies an information lead, e.g., the complete identification of a potential buyer. For example, the full-disclosure information 500 can include the name 502 of a potential buyer. The address 504 of the potential buyer can also be included. The telephone number 506 and a mobile phone number 508 of the potential buyer can also be included in the full-disclosure formation. Other contact information such as a buyer's email address 510 can also be included. In one embodiment, the partial-disclosure information 400 is also included in the full-disclosure information 500. However, this combination of the partial-disclosure information into the full-disclosure information is not necessary in all cases.

It is sufficient that an on-line auction site provide partial-disclosure information to all subscribing bidders during an on-line auction while thereafter provide full-disclosure information only to the winning bidder, where the full-disclosure information does not include the previously provided partial-disclosure information. Once a winning bidder receives the full-disclosure information 500, the potential buyer can then be contacted to start negotiations. In one embodiment the auction system can take a commission on the winning bid value of the lead or a commission on completion of the underlying transaction. One advantage of the present invention is that an on-line marketplace is provided for the trading of informational leads. Individuals looking to sell, rent, or lease particular items can search for and place bids on various informational leads.

Exemplary Quality Rating Algorithm for Informational Leads

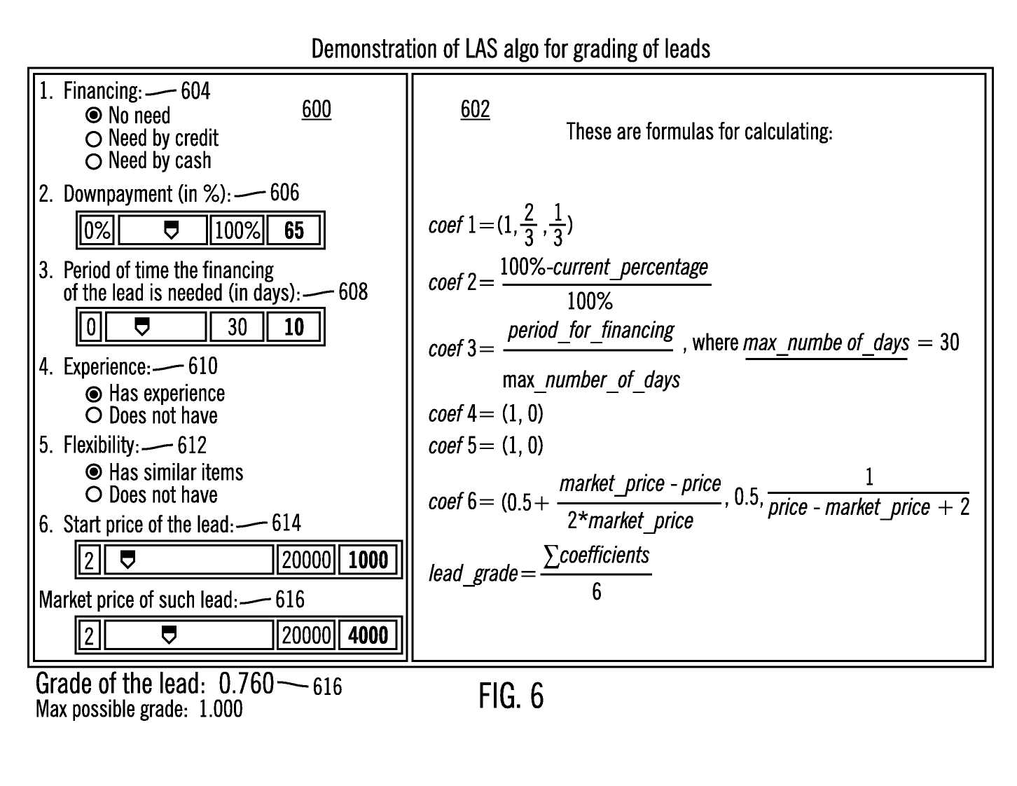

FIG. 6 illustrates one example of a user interface 600 for associating a quality rating with an informational lead. FIG. 6 also shows an exemplary algorithm 602 used for determining a quality rating for an informational lead. It should be noted that the metrics shown in FIG. 6 for determining a quality rating are not limiting and one of more metrics can be added and/or deleted. Furthermore, it should be noted that the assignment of a quality rating can be performed automatically when an information lead is submitted.

As an example, the user interface 600 of FIG. 6 shows six exemplary metrics used for generating a quality rating for an informational lead. The first metric 604, “financing”, reflects the financing needs of a buyer that is associated with the informational lead. For example, the buyer may need financing by credit, cash, or not require financing at all. The quality rating algorithm 602 associates a value with the type of financing required. For example, a selection of indicating that financing is not required is given a higher value than a selection indicating that financing is required.

The second metric 606 is “down payment”, which reflects how much a buyer associated with the informational lead is willing/able to put down on the requested item. The quality rating algorithm 602, in one embodiment, translates this selection into a decimal value by talking subtracting the selected down payment percentage from 100 and dividing the result by 100. The third metric 608 reflects the period of time that the financing is required by the buyer. For example, FIG. 6 shows that the buyer needs financing for a period of 10 days. This selection is translated into a decimal value by the quality rating algorithm 602 by dividing the requested time period for financing by a maximum financing period. For example, the maximum financing period can be 30 days. The fourth metric 310 reflects the experience of the buyer with respect to the item requested. In this example, a buyer with experience is given a higher value (e.g. 1) than a user without experience (e.g. 0).

The fifth metric 612 reflects a buyer's flexibility with the item requested. For example, a buyer may be willing to accept a different color or model type than what is requested. In this example, a higher value (e.g. 1) is given when a buyer is willing to accept similar or different items than when the buyer is not flexible. The sixth metric, “start price” and “market price” reflects the how far off the market price a potential buyer is willing to pay for a requested item. The quality rating algorithm 602 then generates a value based on starting and market prices selected. Once the quality rating algorithm 602 has generated all required coefficients, it takes the sum of all the coefficients and divides them by the number of metrics used. The result of a value or “grade” that is assigned to the informational lead. In the example of FIG. 6, the highest “grade” is 1.

Exemplary Quality Rating Algorithm for an Owner of an Informational Lead

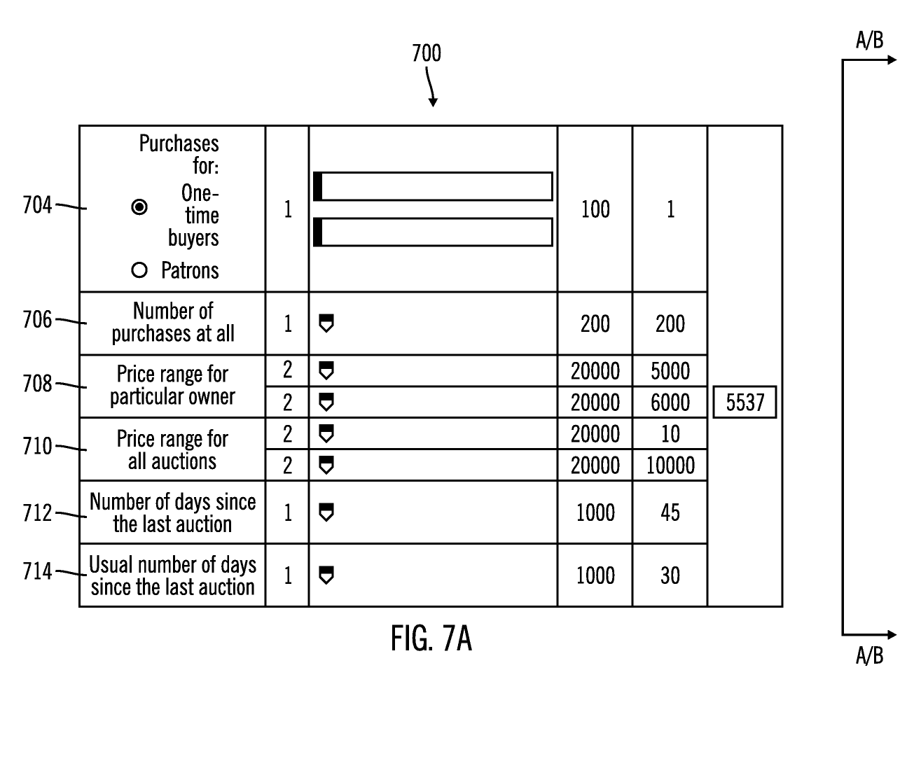

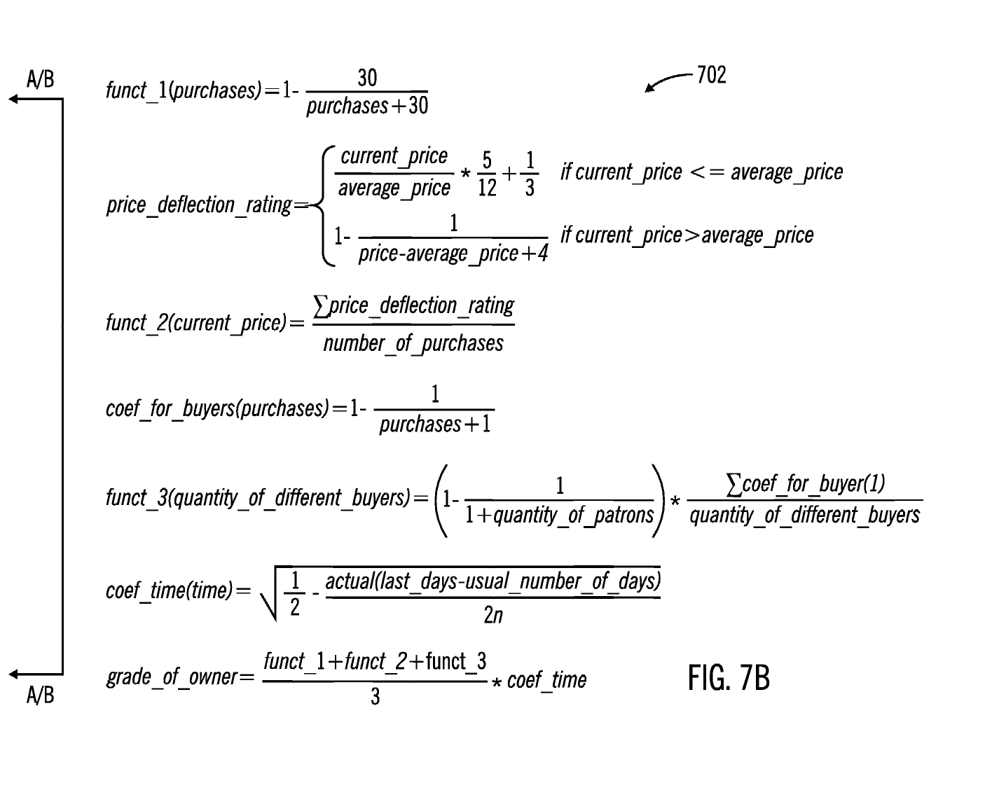

FIG. 7 illustrates one example of a user interface 700 for assigning a quality rating to an owner of an informational lead. This helps a potential bidder of a lead to better decide the legitimacy of an informational lead. FIG. 7 also shows an exemplary algorithm 702 used for determining a quality rating for an owner of an informational lead. It should be noted that the metrics shown in FIG. 7 for determining a quality rating are not limiting and one of more metrics can be added and/or deleted. Furthermore, it should be noted that the assignment of a quality rating can be performed automatically when an information lead is submitted.

As an example, the user interface 700 of FIG. 7 shows six exemplary metrics used for generating a quality rating for an owner of an informational lead. The first metric 704, “purchases”, reflects how many one-time buyers have won bids associated with informational leads of the owner. The “purchases” metric also shows how many repeat customers have won bids owned by the particular owner. The second metric 706 reflects the total number for every informational lead auction. This metric allows for the number of informational leads sold by an owner to be compared with an overall number of leads sold on the on-line auctioning site.

The third metric 708, reflects the prince range of the owner's informational leads and the fourth metric 710 reflects the price ranges of all the informational leads on the auctioning site. This allows for a comparison is made between the owner's leads and all of the information leads as a whole. The fifth and sixth metrics 712, 714 reflect the time since the owner's last auction and the average time between auctions, respectively. These metrics are used to better understand an owner's auctioning habits. The algorithm 702, based on the metric information, can then generate an owner grade that is displayed to potential bidders.

Exemplary Process of Auctioning Informational Leads

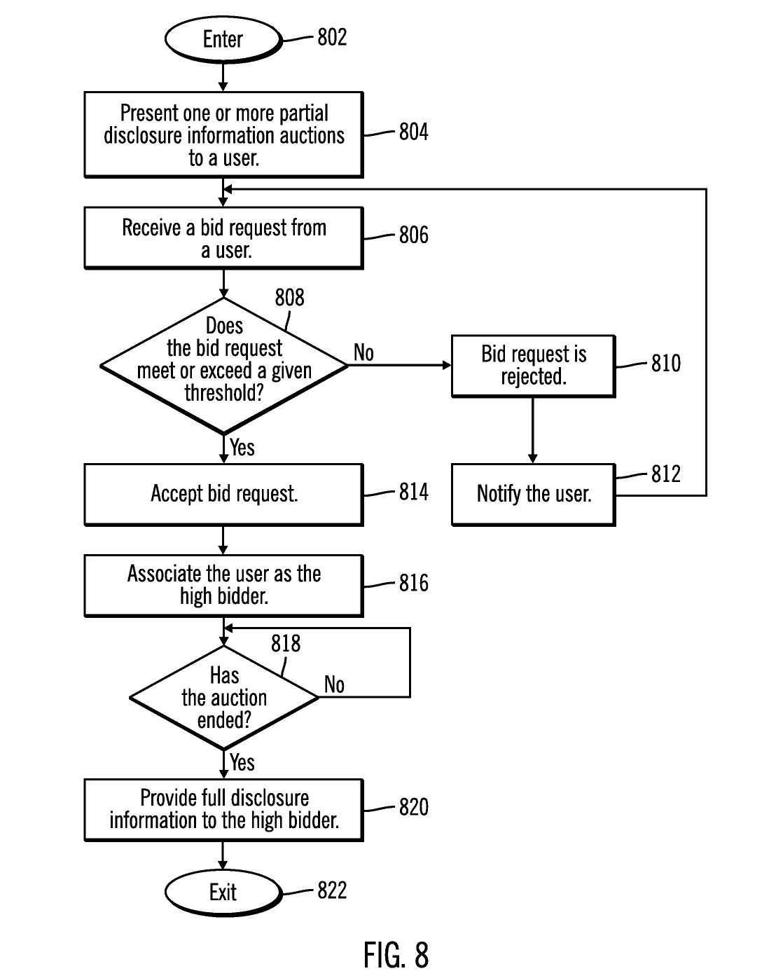

FIG. 8 is an operational flow diagram illustrating an exemplary process of auctioning informational leads via presenting partial disclosure information. The operational flow diagram of FIG. 8 begins with step 802 and flows directly to step 804. The on-line trading server 106, at step 804, presents one or more partial-disclosure information auctions to a user. This presentation can be in response to a search performed by a user, home page preferences of the user, category selection made by the user, or the like. In one embodiment, the user can search for partial-disclosure information auctions matching a given quality or quality range.

The on-line trading server 106, at step 806, receives a bid request from the user. The on-line trading server 106, at step 808, determines whether the bid request meets or exceeds a given threshold. For example, the on-line trading server 106 determines whether the bid request is higher than a current high bid price, meets a fixed selling price, meets or exceeds a reserve prices, and the like. If the result of this determination is negative, the on-line trading server 106, at step 810, rejects the bid request and the user, at step 812, is notified. If the result of this determination is positive, the on-line trading server 106, at step 814, accepts the bid request.

The on-line trading server 106, at step 816, associates the user with a high bidder status. The on-line trading server 106, at step 818, determines if the auction has ended. If the result of this determination is negative, the on-line trading server 106 continues to monitor the time remaining for the auction. If the result of this determination is positive, the on-line trading server 106, at step 820, provides full disclosure information to the high bidder. The control flow then exits at step 822.

Exemplary Process of Assigning a Quality Rating to an Informational Lead

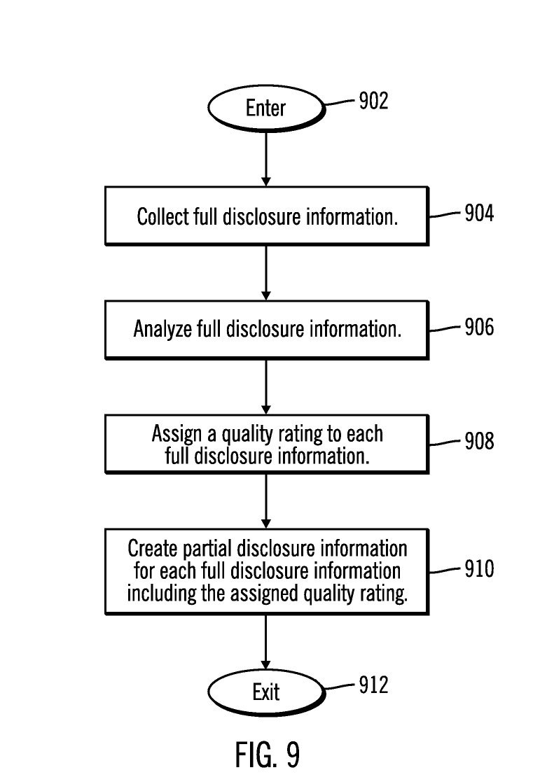

FIG. 9 is an operational flow diagram illustrating an exemplary process of assigning a quality rating (quality metric) to an informational lead (information associated with the potential buyer) according to one embodiment of the present invention. The operational flow diagram of FIG. 9 begins with step 902 and flows directly to step 904. The on-line trading server 106, at step 904, collects full disclosure information. For example, an automated process can collect full disclosure information from various sources such as the Internet. Alternatively, full disclosure information can be manually collected.

The on-line trading server 106, at step 906, analyzes the full disclosure information. For example, based on information such as the time period associated with the lead for obtaining an item the on-line trading server 106 can analyze this time period and determine a quality metric for the lead. For example, an information lead that is associated with a likely purchase within the next week may be associated with a high quality rating. On the other hand, an information lead that is associated with a potential purchase in an undetermined time in the future may be associated with a low quality rating. Other aspects of the information lead may be also analyzed by the server 106 to arrive at a quality rating that represents a composite of all the analyzed aspects of the information lead to arrive at the final quality rating.

The on-line trading server 106, at step 908, assigns a quality rating to the full disclosure information based on the analysis. The quality rating can also be manually added by an administrator of the auctioning service after manually reviewing the full disclosure information. Additionally, in one example of an on-line auction system, an assignment of a quality rating can be effected by a combination process including a manual review and assignment of quality rating information that is then used by the server 106 in combination with an automated review and assignment of quality rating information to generate a final quality metric associated with the informational lead. Partial disclosure information, at step 910, is created for each of the full disclosure information including the assigned quality rating (or quality metric). The control flow then exits at step 912.

Non-Liming Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Embodiments of the invention can be implemented as a program product for use with a computer system such as, for example, the computing environment shown in FIG. 1 and described herein. The program(s) of the program product defines functions of the embodiments (including the methods described herein) and can be contained on a variety of computer readable media. Illustrative computer readable medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such computer readable media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for providing an on-line trading environment of informational leads, the method comprising:
presenting an on-line auction to a user, wherein the on-line auction presents to the user partial-disclosure information associated with an informational lead; and
receiving a bid request from the user for the informational lead based on the partial-disclosure information presented in the on-line auction, wherein the informational lead includes full disclosure information associated with a potential customer.

2. The method of claim 1, further comprising:
associating the partial-disclosure information with a quality metric; and
presenting the quality metric to the user in association with the presenting of the partial-disclosure information.

3. The method of claim 2, wherein the quality metric is based on a readiness of a buyer associated with the partial-disclosure information to make a purchase.

4. The method of claim 1, wherein the partial disclosure informational presented to the user comprises a portion of lead identification information associated with at least one buyer, wherein the portion of lead identification information presented to the user prevents the user from circumventing the on-line auction to contact the at least one buyer.

5. The method of claim 1, further comprising:
transmitting real-time information associated with the auction to a group of users subscribed to the auction, wherein the real-time information associated with the auction is transmitted contemporaneous with an auction event occurring, and wherein the transmission of the real-time information is unevoked by the group of users.

6. The method of claim 5, wherein the auction event comprises at least one of:
a bid being placed in the auction; and
a given period of time existing prior to the auction closing, and wherein
the transmitted real-time information represents the auction event to the group of users.

7. The method of claim 1, further comprising:
determining if the received bid request is higher than a given threshold;
if the received bid request is higher than the given threshold, setting a user ID associated with the user as a current high bidder for the on-line auction; and
if the received bid request is lower than the given threshold, rejecting the received bid request.

8. The method of claim 1, further comprising:
determining that a time interval associated with the on-line auction has expired; and
providing to a user who is a current high bidder after the on-line auction ends the full-disclosure information including identification of the potential customer, wherein the full-disclosure information comprises the partial-disclosure information.

9. The method of claim 8, wherein the full disclosure information includes at least contact information associated with the potential customer.

10. The method of claim 1, further comprising:
displaying a list of on-line auctions to the user, wherein each on-line auction in the list of on-line auctions is associated with at least one partial-disclosure information being auctioned in the respective each on-line auction.

11. The method of claim 10, wherein the displaying includes:
displaying partial-disclosure information for each on-line auction in the list displayed to the user; and
displaying a quality metric associated with the displayed partial-disclosure information for each on-line auction, wherein the displayed quality metric indicating a quality of an informational lead associated with the displayed partial-disclosure information for each on-line auction in the list.

13. A method, with an information processing system, for providing an on-line trading environment of informational leads associated with prospective customers, the method comprising:
presenting an on-line auction to a user, wherein the on-line auction presents to the user partial-disclosure informational leads indicating a commercial interest of a prospective customer; and
receiving a bid request from the user on the basis of the partial-disclosure informational leads in the on-line auction, wherein the bid request represents an offer for purchasing full disclosure information associated with the partial-disclosure informational leads for identifying the prospective customer.

14. The method of claim 13, further comprising:
associating the partial-disclosure informational leads with a quality metric that is provided to the user; and
presenting the quality metric to the user in association with the auctioning of the partial-disclosure informational leads.

15. The method of claim 14, wherein the quality metric is based on a readiness of a buyer associated with the partial-disclosure informational lead to make a purchase.

16. The method of claim 13, further comprising:
determining if the received bid request is higher than a given threshold;
if the received bid request is higher than the given threshold, setting a user ID associated with the user as a current high bidder for the auction;
if the received bid request is lower than the given threshold, rejecting the received bid request;
determining that a time interval associated with the auction has expired; and
providing to a user who is a current high bidder after the auction ends the full-disclosure information.

17. The method of claim 13, further comprising:
transmitting real-time information associated with the on-line auction to a group of users subscribed to the on-line auction, wherein the real-time information associated with the on-line auction is transmitted contemporaneous with an on-line auction event occurring, and wherein the transmission of the real-time information is unevoked by the group of users.

18. A system for providing an on-line trading environment of partial-disclosure informational leads, the system comprising:
a memory;
an information processing system communicatively coupled to the memory, the information processing system comprising at least
an on-line auction user interface for allowing a user to interact with a partial-disclosure informational lead auction; and
a user input receiver for receiving at least a bid request from the user for a partial-disclosure informational lead being auctioned in the on-line auction.

19. The system of claim 18, wherein the information processing system further comprises:
an auction item analyzer for associating the partial-disclosure informational lead with a quality metric, wherein the quality metric is presented to the user in association with the auctioning of the partial-disclosure informational lead.

20. The system of claim 18, wherein the partial disclosure informational lead comprises a portion of lead identification information associated with at least one buyer, wherein the portion of lead identification information prevents the user from circumventing the on-line auction to contact the at least one buyer.

21. The system of claim 18, wherein the information processing system further comprises:
a user input analyzer for determining if the received bid request is higher than a given threshold, wherein if the received bid request is higher than the given threshold, a user ID associated with the user is set as a current high bidder for the auction, and wherein if the received bid request is lower than the given threshold the received bid request is rejected;
an auction analyzer for determining that a time interval associated with the auction has expired; and
a transmitter for providing to a user who is a current high bidder after the auction ends a full-disclosure information associated with the partial-disclosure informational lead, wherein the full-disclosure information comprises at least contact information associated with a buyer to make a purchase.
